(19) United States
(12) Patent Application Publication
(10) Pub. No.: US 2025/0362404 A1
(43) Pub. Date: Nov. 27, 2025

(54) METHOD FOR MEASURING THE ROTATIONAL SPEED OF AN ELECTRIC MACHINE

(71) Applicant: Voith Patent GmbH, Heidenheim (DE)

(72) Inventors: Alexander Jung, Lorch (DE); Babette Schwarz, Syrgenstein (DE); Ludger Ködding, Heidenhiem (DE)

(73) Assignee: Voith Patent GmbH, Heidenheim (DE)

(21) Appl. No.: 19/291,198

(22) Filed: Aug. 5, 2025

Related U.S. Application Data
(63) Continuation of application No. PCT/EP2023/085077, filed on Dec. 11, 2023.

(30) Foreign Application Priority Data
Feb. 7, 2023 (DE) 10 2023 102 887.1

(51) Int. Cl. G01S 13/58

(52) U.S. Cl. CPC G01S 13/583

(57) ABSTRACT

A method for measuring a rotational speed of an electric machine includes: detecting, while a rotor rotates and by a radar system, time-varying periodic distance values and transmitting, by the radar system, the time-varying periodic distance values to the data processing unit; calculating, by the data processing unit, the rotational speed of the rotor from the transmitted time-varying periodic distance values; calculating, by the data processing unit, an additional characteristic number of the rotor from the transmitted time-varying periodic distance values, the additional characteristic number of the rotor including a width of an air gap; detecting, by the radar system, time-varying distance values to a part of the stator that is detected and transmitting the time-varying distance values to the data processing unit; calculating, by the data processing unit, a vibration characteristic number for the stator from the transmitted time-varying distance values.

### CROSS REFERENCE TO RELATED APPLICATIONS

This is a continuation of PCT application no. PCT/EP2023/085077, entitled “METHOD FOR MEASURING THE ROTATIONAL SPEED OF AN ELECTRIC MACHINE”, filed Dec. 11, 2023, which is incorporated herein by reference. PCT application no. PCT/EP2023/085077 claims priority to German patent application no. 10 2023 102 887.1, filed Feb. 7, 2023, which is incorporated herein by reference.

### BACKGROUND OF THE INVENTION

### 1. Field of the Invention

The present invention relates to measuring the speed of an electric machine.

### 2. Description of the Related Art

Methods for measuring the speed of an electric machine are known from the prior art. In many cases, lock washers are scanned with a sensor (see, for example, U.S. Pat. No. 11,486,251 B2). Inductive sensors and Hall sensors are known as sensors (see, for example, DE 10 2004 046 824 A1). Further, the use of optical sensors is well-known.

What is needed in the art is an alternative method which, as an additional advantage, makes it possible to record a further characteristic value of the electric machine, in addition to the speed.

DE 10 2010 009 663 A1 discloses a method for measuring rotational speed of an electric machine with the help of a radar system. In addition, the air gap width and vibrations of the work spindle can be detected using the method as disclosed. U.S. Pat. No. 5,760,731 A discloses a further method for measuring the rotational speed of an electric machine with the help of a radar system, wherein additionally vibrations of the rotor can be detected. US 2019/0020244 A1 discloses a method for monitoring the air gap using a radar system. DE 10 2018 123 845 A1 discloses a method for monitoring the winding head of the rotor of an electric machine with the help of a radar system, wherein the radar system can detect a deformation of the winding head. DE 10 2014 215 008 A1 discloses a method for determining an angle of attack of rotor blades of a turbine with the aid of a radar system.

What is also needed in the art is an alternative method, which makes it possible as an additional advantage to also detect a further characteristic variable of the electric machine, in addition to the rotational speed and the width of the air gap.

### SUMMARY OF THE INVENTION

The invention relates to a method for measuring the speed of an electric machine. The electric machine is optionally, but not exclusively, a large electric machine such as is used, for example, in hydro-electric power plants.

The present invention provides for the use of a specially designed radar system.

The present invention provides a method for measuring the rotational speed of an electric machine including a rotor (3), a stator (4), at least one radar system (1) and a data processing unit (2), and wherein at least one radar system (1) is arranged in such a way that it can detect a part of the rotor (3), and wherein the electric machine has an air gap, which is arranged between the rotor (3) and the stator (4), and wherein the part of the rotor (3) detected by at least one radar system (1) is arranged in the interior of the stator (4), and wherein the radar system (1) is so disposed that it can detect a part of the stator (4), and whereby the method includes the following steps:
S1: While the rotor (3) rotates, the at least one radar system (1) detects periodically varying periodic distance values and transmits the same to the data processing unit (2);
S2: Calculating the rotational speed of the rotor (3) from the transmitted distance values by the data processing unit (2);
S3: Calculating at least one further characteristic number of the rotor (3) from the transmitted distance values by the data processing unit (2), and wherein at least one further characteristic number includes a width of the air gap;
S4: Detecting time-varying distance values to the detected part of the stator (4) by at least one radar system (1) and transmitting the same to the data processing unit (2);
S5: Calculating a vibration characteristic number for the stator (4) from the distance values transmitted in S4 by the data processing unit (2).

The present invention further provides the method for measuring the rotational speed of an electric machine, wherein optionally at least one further characteristic number of the rotor includes a vibration characteristic number.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a radar system;

FIG. 2 is an electric machine according to an embodiment of the present invention;

FIG. 3 is an electric machine according to a further embodiment of the present invention;

FIG. 4 is an electric machine according to a further embodiment of the present invention;

FIG. 5 is an electric machine according to a further embodiment of the present invention;

FIG. 6 is an said electric machine;

FIG. 7 is an electric machine according to a further embodiment of the present invention; and

FIG. 8 is an electric machine according to a further embodiment of the present invention;

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

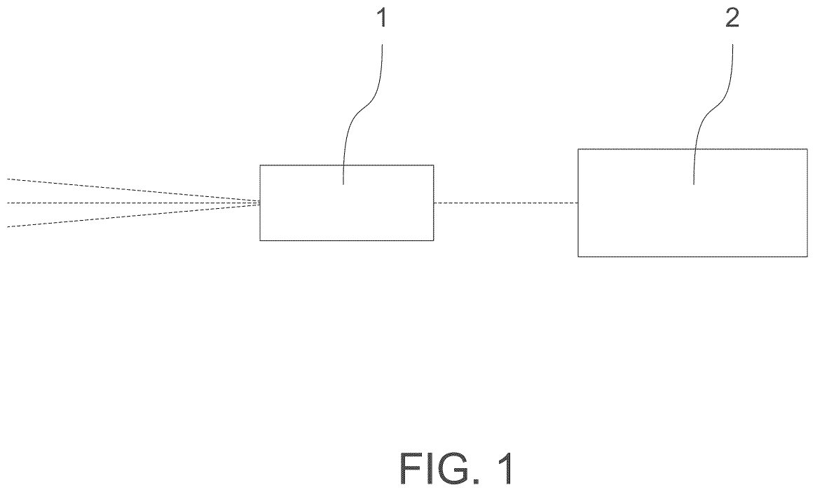

FIG. 1 shows a highly schematic representation of a radar system for application in the said method. The radar system is designated 1. A radar system usually includes a transceiver with a transmitting and a receiving antenna and a control device. The transmitting and receiving antennas can be designed separately as two individual antennas or integrated as one antenna that can perform both the transmitting and receiving functions. The control device usually includes a microprocessor that controls the transceiver and processes the received signal. The radar system 1 can, for example, be designed as a CW (Continuous Wave) or as an FMCW (Frequency Modulated Continuous Wave) radar system. In any case, the radar system 1 is designed such that it can provide a measured value as a function of time that represents a distance. This can refer to a distance between the radar system 1 and an object detected by the radar system 1 or a distance between two objects detected by the radar system 1 (i.e., a distance differential). The dashed lines in FIG. 1 indicate the radiation cone of the radar system 1, i.e., the radiation characteristics of the transmitting antenna. The radar system 1 is connected to a data processing unit, designated with 2. The connection can be wired or wireless. The data processing unit 2 is not shown in the following figures.

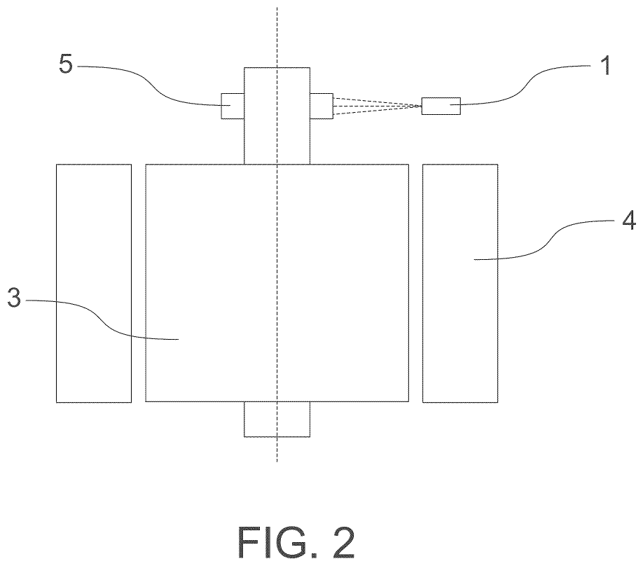

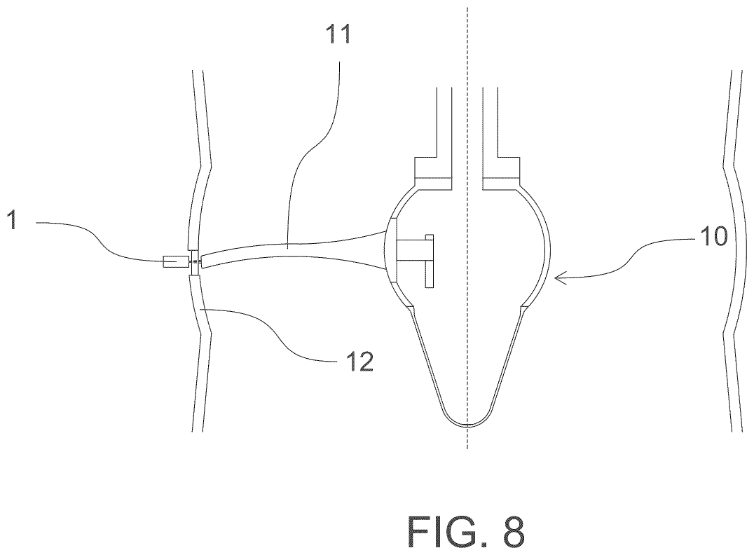

FIG. 2 shows an electric machine suitable for carrying out a method. The electric machine includes a stator, designated with 4, and a rotor that is designated with 3. The dashed line indicates the axis of rotation of rotor 3. In the context of this document, the term “rotor” is used very broadly. In addition to the “actual rotor” commonly used in everyday language, according to the understanding of this document, all objects connected with the “actual rotor” belong to the rotor, i.e., all objects that rotate with the “actual rotor”. In doing so, it relates to objects that do not belong to the electric machine according to the usual usage. Thus, as per the understanding of this document, for example, in an electrically operated model airplane the propeller belongs to the rotor of the electric machine, or in a hydro-electric power station the impeller of the hydraulic machine belongs to the rotor of the electric machine (see FIG. 8). The connection between the objects in question and the “actual rotor” can be direct, so that the objects rotate at the same speed as the “actual rotor”, or indirectly via a gear, so that the speeds differ. In the second case, there is a known connection between the different speeds, so that one speed can be derived from the other by multiplying it with a known constant.

In the case of the electric machine in FIG. 2, the rotor 3 includes a shaft and a lock washer connected to the shaft, which is designated with 5. Further, the electric machine also includes a radar system, which is designated with 1. Basically, the radar system 1 is so disposed that it can detect a part of the rotor 3. In FIG. 2, the part of the rotor 3 that is detected by the radar system 1 is the lock washer 5. The lock washer 5 includes projections, which cause the radar system 1 to transmit the distance values that vary with time to the data processing unit 2, when rotor 3 rotates. If a cog of the lock washer 5 is located directly in front of the radar system, then it detects a smaller distance than as if no cog is located directly in front of the radar system. The number of cogs on the lock washer and the speed of the rotor determine the frequency with which long and short distances alternate. Since the number of cogs on the lock washer is known, the speed of the rotor can be calculated from the detected distance values.

Said procedure includes the following steps:
S1: While the rotor 3 rotates, the radar system 1 detects the distance values that vary with time and transmits them to the data processing unit 2;
S2: Calculation of the rotational speed of the rotor 3 from the transmitted distance values by the data processing unit 2.

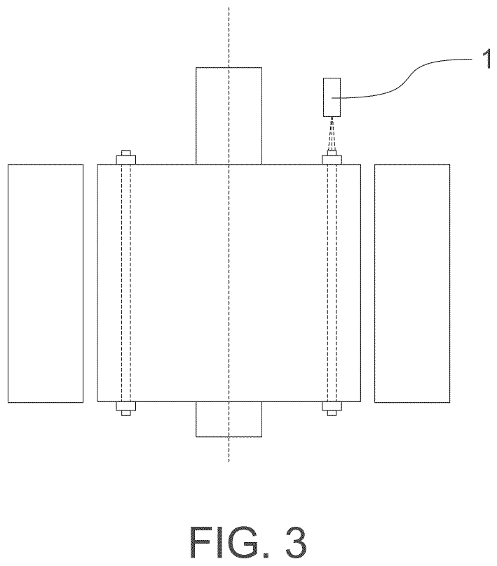

The inventors have recognized that the rotors of several electric machines are designed in such a way that a lock washer intended for speed measurement can be dispensed with. This is illustrated by the embodiment of FIG. 3. Several rotors include a laminated core, which is held together by clamping bolts. The ends of the clamping bolts protrude beyond the laminated core. They are usually arranged uniformly around the axis of rotation. If the radar system is arranged in a manner that is shown in FIG. 3, then it can detect the clamping bolt ends, which periodically appear in front of the radar system and disappear again when the rotor rotates. This would result in a sequence of distance values analogous to the sequence of distance values detected with a lock washer. Depending on the design of the respective electric machine, other rotor areas can be used for speed measurement. Further examples of this are explained in connection with the remaining figures available in this document.

First, however, another aspect of the present invention will be discussed. The inventors have recognized that with the aid of the said arrangement, further important parameters of the electric machine can be determined and monitored without the need for additional equipment. Another possible parameter is vibration. Vibration monitoring enables timely detection of malfunctions and prevention of associated damage to the electric machine. The inventors have recognized that with the aid of the radar system, both the distances required for speed measurement and the distance variations that provide information about vibrations in the electric machine can be detected simultaneously. In order to measure vibrations, it may only be necessary to increase the sampling rate accordingly. The vibration parameters determined in this way initially relate to the part of the rotor detected by the radar system. Since vibrations spread across the entire rotor regardless of their cause, the vibration parameters determined in this way are in any case a measure of the smooth running of the electric machine. This means that the said vibration measurement can always be combined with the speed measurement (i.e., with every conceivable arrangement of the radar system).

Said method, therefore, optionally includes the following step, in addition:
S3: Calculation of at least one further characteristic number of rotor 3 from the transmitted distance values by the data processing unit 2; wherein the at least one further characteristic index is a vibration characteristic number.

The inventors have recognized that in addition to the vibration parameters, there are also other parameters that can be determined simultaneously with the speed determination. Other parameters that can be determined depend on the design of the electric machine and the arrangement of the radar system. The following figures show some examples of the possible arrangements and the associated key figures to be determined.

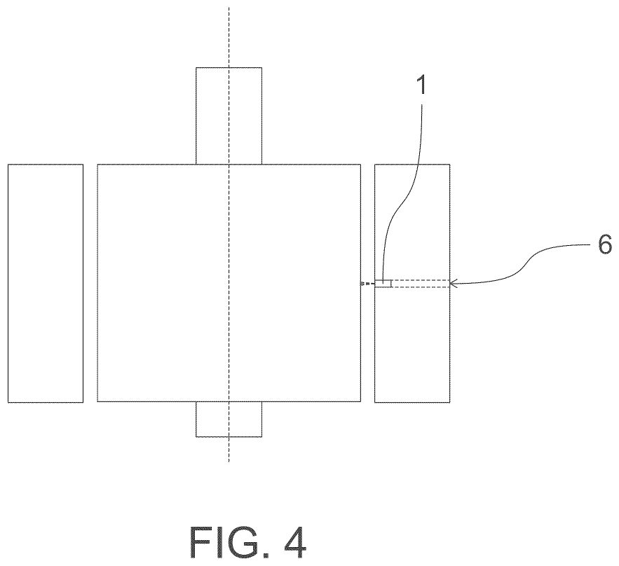

FIG. 4 shows an electric machine, which includes a multitude of ventilation slots which are arranged in the stator. Only one of the ventilation slots is shown and is designated 6. The radar system 1 disposed in the ventilation slot 6 is shown in such a way that it can detect the outer contour of a part of the rotor, which is arranged inside the stator. The beams emanating from the radar system 1 penetrate the air gap of the electric machine, which is located between the stator and the part of the rotor disposed inside the stator, in a radial direction. Thanks to this arrangement, it is possible to determine the air gap width from the distance values that are detected by the radar system 1, whereby monitoring the air gap is enabled. In other words, the additionally calculated characteristic value of the said method relates to the air gap width.

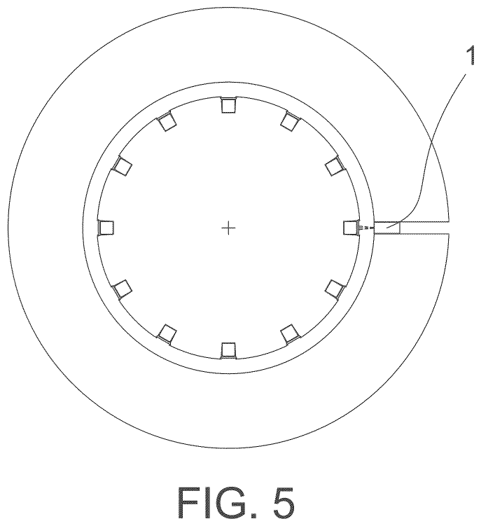

FIG. 5 shows the arrangement of FIG. 4 in a section perpendicular to the rotational axis of the electric machine. FIG. 5 is used to explain how the rotational speed of the electric machine can be determined with the help of the arrangement shown. This is made possible by the fact that in several electric machines the outer contour of the rotor part arranged inside the stator is by no means a perfect cylinder shell. In case of the machine shown here, the rotor winding consists of conductor bars that are arranged in slots in the rotor body. The conductor bars are held in the slots by slot lock wedges. The so-called cogs are located between the slots. The slot lock wedges are set back slightly inwards vis-à-vis the cogs. This would result in an outer contour, which can be compared to a lock washer and which thus enables the rotational speed to be measured using the arrangement as shown. Several electric machines of other designs also have similar outer contours, e.g., electric machines with rotors in the form of a salient pole rotor. Said method can be used in the manner as described, whenever the outer contour deviates from the cylinder shell shape. If this is not the case, as is the case with most electric machines, then this can, of course, be achieved by adding small projections or by cutting small grooves.

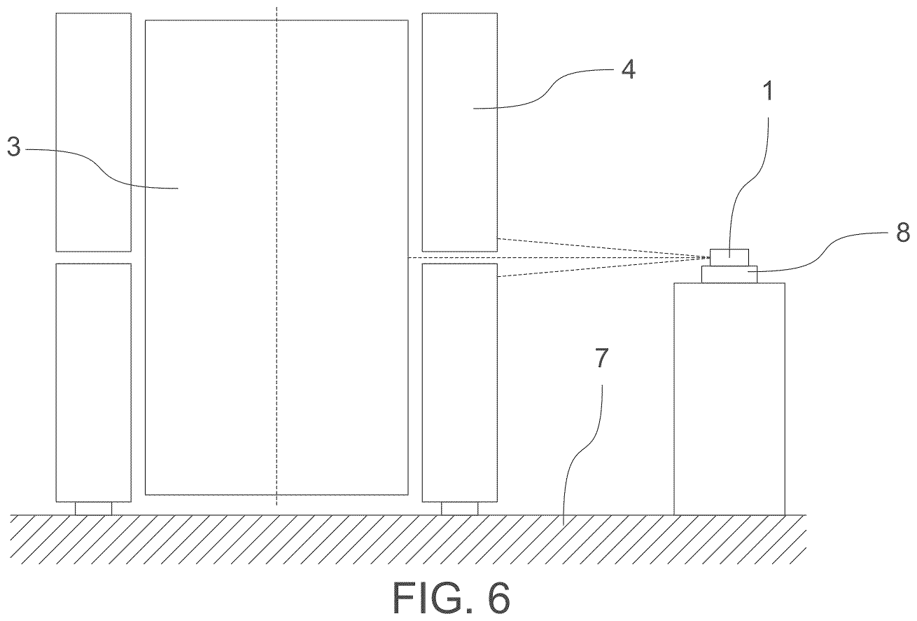

FIG. 6 shows the said set-up, which in addition to monitoring the air gap and vibrations of the rotor also enables vibration monitoring of the stator. As shown in FIGS. 4 and 5, the beams of the radar system 1 penetrate the air gap in a radial direction. In contrast to FIGS. 4 and 5, the radar system 1 is disposed outside the stator 4. The beams of the radar system 1 penetrate the stator 4 through a suitable opening in the stator 4 and detect part of the rotor. At the same time, the radar system 1 detects part of the stator 4, which enables vibration monitoring of the same. In this connection, it is advantageous if the radar system 1 is decoupled from the stator 4. As regards vibrations, the stator 4 and the radar system are connected to a foundation, which is designated with 7. A vibration decoupling device, which is designated with 8, is arranged between the foundation 7 and the radar system 1. Said method includes the following steps:
S4: Detection of distance values that vary with time to the detected part of the stator 4 by the radar system 1 and transmission of the same to the data processing unit 2;
S5: Calculation of a vibration index for the stator 4 from the distance values transmitted in S4 by the data processing unit 2.

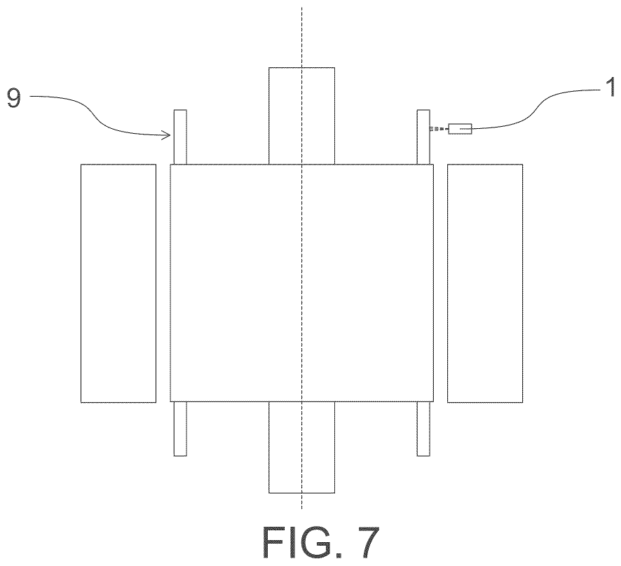

FIG. 7 shows an arrangement, which enables determination of a further characteristic value of the electric machine in question here. The electric machine includes a winding head, which is formed by the winding ends projecting in the axial direction beyond the rotor body and is designated with 9. The radar system 1 is arranged in such a way that it can detect the rotor in the area of the winding head 9. The arrangement shown here makes it possible to determine and monitor the deformation of the winding head 9, which is caused by the effect of centrifugal force. It is clear that the design of the winding head 9 enables simultaneous measurement of the speed without any problem.

As already mentioned above, according to the understanding of the present document, the rotor includes all objects that are connected to it and rotate with it. In a hydro-electric plant, this relates to, for example, the impeller of the hydraulic machine connected to the electric machine. FIG. 8 shows such a set-up including an impeller, which is designated with 10. The impeller 10 rotates in a so-called impeller ring, which is designated with 12. The impeller 10 is of Kaplan type and includes a plurality of pivoting impeller blades, of which only one is shown and is designated with 11. The radar system 1 is so arranged it can detect the radial ends of the impeller blades 11 through a window in the impeller ring 12, which move past the window when the impeller 10 rotates. In doing so, the radar beams penetrate the gap between the window and the impeller ends in a radial direction. From what has been said, it is clear that the arrangement depicted here enables monitoring of the gap width and the vibration of the impeller 10. The rotational speed of the impeller and thus the speed of the electric machine can also be measured without any problem, since the radar system periodically detects small and large distances during the rotation of the impeller 10. Small distances are detected when a blade end is in front of the window. Large distances are detected when there is a gap between two adjacent blades in front of the window. In addition, the arrangement shown enables the degree of opening of the Kaplan impeller to be measured as a further parameter, since the degree of opening is clearly related to the duty cycle of the periodic distance signal. The duty cycle is the ratio between the length of time for small distance values and the length of time for large distance values. If the blades 11 are pivoted so that the opening degree of the impeller assumes the minimum value, the gaps between the blades are minimal and therefore, the duty cycle is the maximum. At the maximum opening degree, the gaps are the largest and therefore, the duty cycle is minimal. The duty cycle and the resulting opening degree can be used as feedback for the turbine controller.

Said method for measuring the rpm of an electric machine can easily be modified so that it is very easy to determine the azimuthal position of the rotor. In order to do this, it must be ensured that the distance signal detected by the radar system delivers a certain distance once during a full rotation of the rotor. This defined one-time event can then be used for position calibration. Such a one-time event can be generated, for example, by attaching an additional projection or an additional groove at a suitable point in the area of the rotor that is detected by the radar system. Should the direction of rotation be determined further, then another radar system can be used for this purpose, which is arranged in the same way as the first radar system, only offset in the azimuthal direction.

From the examples described, the person skilled in the art can easily derive further applications of the said method for specific electric machines without having to perform an inventive activity.

### LIST OF REFERENCE SYMBOLS

1 Radar system
2 Data processing unit
3 Rotor
4 Stator
5 Lock washer
6 Ventilation slot
7 Foundation
8 Vibration decoupling
9 Winding head
10 Impeller of a hydraulic machine
11 Blade
12 Impeller ring

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for measuring a rotational speed of an electric machine, the method comprising the steps of:
providing that the electric machine includes a rotor, a stator, at least one radar system, and a data processing unit, wherein the at least one radar system is arranged in such that the at least one radar system is configured for detecting a part of the rotor, wherein the electric machine includes an air gap, which is arranged between the rotor and the stator, wherein the part of the rotor that is detected by the at least one radar system is arranged in an interior of the stator, and wherein the at least one radar system is so disposed that the at least one radar system is configured for detecting a part of the stator;
detecting, while the rotor rotates and by way of the at least one radar system, a plurality of time-varying periodic distance values and transmitting, by way of the at least one radar system, the plurality of time-varying periodic distance values to the data processing unit;
calculating, by the data processing unit, the rotational speed of the rotor from the plurality of time-varying periodic distance values, which are transmitted;
calculating, by the data processing unit, at least one first additional characteristic number of the rotor from the plurality of time-varying periodic distance values which are transmitted, wherein the at least one additional characteristic number of the rotor includes a width of the air gap;
detecting, by the at least one radar system, a plurality of time-varying distance values to the part of the stator that is detected and transmitting the plurality of time-varying distance values to the data processing unit;
calculating, by the data processing unit, a first vibration characteristic number for the stator from the plurality of time-varying distance values transmitted in the transmitting of the plurality of time-varying distance values to the data processing unit.

2. The method according to claim 1, wherein at least one second further characteristic number of the rotor includes a second vibration characteristic number.
